(19) United States
(12) Patent Application Publication
(10) Pub. No.: US 2004/0093100 A1
(43) Pub. Date: May 13, 2004

(54) Method for providing production-related data, especially of motor vehicles

(76) Inventor: Stefan Gleis, Hemmingen (DE)

Correspondence Address: Robert W Becker & Associates, Suite B, 707 Highway 66 East, Tijeras, NM, 87059, US

(21) Appl. No.: 10/333,647

(22) PCT Filed: Jul. 3, 2001
(86) PCT No.: PCT/EP01/07585

(30) Foreign Application Priority Data
Jul. 20, 2000 (DE) 100 34 606.5

(51) Int. Cl. G06F 19/00

(52) U.S. Cl. 700/95; 700/117

(57) ABSTRACT

The invention relates to a method for providing production-related data in the series production of produced objects, especially motor vehicles, according to which production-related data is recorded in at least a part of the production steps of the series production process. The inventive method is characterised in that images of defective sites on the produced objects are recorded with a camera and in that during the production process, the recorded images are transmitted to at least one central device. The inventive method provides a rapid, simple and comfortable means of documenting defects in produced objects. The recorded images and production-related data that may be optionally added to these images are already available at the central device and can be evaluated at a time when the produced object is still in the production process. This facilitates the planning of refinishing considerably, which in turn saves time and reduces costs.

The invention relates to a method of the type in the pre-characterizing clause of Claim 1 for making available production-related data in a series production process for the production of produced objects, especially motor vehicles.

A method of this respective technical art is disclosed in DE 198 29 366 C2. In this known method, each produced object has a data acquisition device associated therewith, whereby, in at least a portion of the finishing or fabricating section of the series production process, production-related data is inputted into the data acquisition device and whereby the data is, during the finishing process, at least partially transmitted from the respective data acquisition device to at least one central device. Since, in connection with this method as set forth in the above-noted publication, the production-related data gathered by the workers has already been made available during the finishing process to a central device, it is no longer necessary to wait, from the point of view of planning of the follow-on work, until a produced object has completely passed through the entire finishing process. The planning of follow-on work, which is to be undertaken with respect to the produced object, after having passed through the finishing process, can therefore already be performed at a point in time during which the produced object is still in passage through the finishing process. This facilitates the planning of follow-on work considerably and leads to a time saving and, consequently, to a cost saving.

In connection with the known method, the identification of defects on the produced object can, for example, be graphically depicted via matrices displayed on a touch screen. This method of identification of defect locations is simple and comfortable.

The invention provides a solution to the challenge of providing a method in accordance with the pre-characterizing clause of claim 1 in which the identification of defect locations on the produced objects is further simplified and the risk or danger of the false inputting of defects is reduced.

This solution is solved in accordance with the inventive teachings set forth in patent claim 1.

The invention provides confirmation of the surprisingly simple concept that defect locations on the produced objects no longer need be identified by means of lists or matrices but, instead, pictures of such defect locations on the produced object are taken by a camera. This picture is transmitted during the finishing process to at least one central device.

At the central device, it can be immediately seen, by viewing of the transmitted pictures available at the central device, which are typically self-explanatory, whether a defect is present on the produced object. Thus, in connection with a vehicle, for example, it can immediately be seen via viewing of the picture whether a component is lacking or is present with a defect or whether, for example, a scratch or a dent in the surface coating of the vehicle is present. This makes possible in a simple and time saving manner an evaluation of the production-related data received during the finishing process representing the defect locations and facilitates thereby the planning of follow-on work.

The central device can, for example, be configured as a server in which the captured picture is archived along with, as the occasion arises, further production-related data. The captured picture can be further transmitted from the server to the follow-on work regions. A plurality of central devices can also be provided which are located in different follow-on work areas. In this connection, it is possible to not send the entire batch of pictures taken with respect to a produced object to all central devices but, rather, to transmit only those pictures to a respective central device which are relevant for the follow-on work region with which the respective central device is associated. Thus, for example, pictures of defect locations in the surface coating of a vehicle are transmitted to a follow-on work region at which the surface coating is subjected to follow-on work, while pictures of defect locations, which relate to missing components are transmitted to a follow-on work region at which these components can be subsequently assembled onto the vehicle.

As a consequence of the fact that the defect locations are captured by the camera, it is generally no longer required that these defect locations be identified in another manner such as, for example, via an entry on a vehicle card or through manual input into a data acquisition device, as is known from DE 198 29 366 C2. In this manner, the danger of false inputting of defects is considerably reduced. As a result of the visual representation of the defect locations, it is, additionally, no longer required that the vehicle cards or the input masks be multi-linqually configured in connection with the computer-controlled inputting of defect data or that such input be possible in different languages if the workers performing the finish work are of different nationalities. This leads, in contrast to the known method, to a considerable simplification and, consequently, to a significant cost saving.

The pictures of defect locations can either be captured as still pictures or moving pictures.

The capture of pictures of defect locations can be performed with a suitable selected camera. For example, the pictures can be produced with an instant picture camera or another analog camera. An especially advantageous further configuration provides, however, that the capture of pictures of defect locations is effected via a digital camera. Digital cameras are available as cost favorable off-the-shelf devices and are easily serviceable. Moreover, these cameras permit the capture of pictures with high resolution. The pictures can, moreover, be stored as digital picture data.

It is, as a general proposition, possible to transmit the pictures in analog form to at least one central device. A useful further configuration provides, however, that the pictures are transmitted as digital picture data to the central device. The transmission of the pictures, in this configuration, is rapid and is possible at a high data transmission rate. In connection with the production and processing of the digital picture data representing the pictures, the pictures can be taken from the first instance via a digital camera. It is also, however, possible to initially capture the pictures in analog form via, for example, an instant picture camera and to thereafter render the analog pictures into digital form via, for example, scanning of the pictures by means of a scanner.

In the interest of expediency, the pictures are captured by workers. In this manner, a particularly high flexibility is provided for the documentation of defect locations.

A useful further configuration of the embodiment comprising the camera provides that the camera is connected with a data acquisition device or is configured as a portion of a data acquisition device. If the data acquisition device is configured, for example, in the form of a hand-held computer, the camera can be configured as a separate module and can be connected with the computer via a port.

It is, as a general proposition, sufficient that the pictures of defect locations are captured without an optical follow-up control performed by a worker and are transmitted to at least one central device. It is, however, useful if the data acquisition device is configured as a screen display device for the display of the captured pictures. In this embodiment, an optical follow-on control of the captured pictures by a worker is possible.

An especially advantageous further configuration of the above-noted embodiment provides that the screen display device is configured as a touch screen via which the production-related data captured by a worker can be inputted into the data acquisition device. In this embodiment, in addition to the captured pictures, still further production-related data can be inputted into the data acquisition device and transmitted to at least one central device. In this connection, in addition to the captured pictures, further production-related data is inputted and transmitted. It is also, however, possible, in certain finishing sections to manually input data into the data acquisition device instead of capturing pictures of defect locations.

It is, as a general proposition, sufficient that the captured pictures are transmitted without follow-on work to at least one central device. An advantageous further configuration in accordance with the inventive teachings provides, however, that the captured pictures are, as required, subjected to follow-on work before transmission thereof to at least one central device, especially for more exact identification and/or classification of defect locations. In this embodiment, the worker can, for example by means of a picture processing program, apply markings to the captured pictures in order to more exactly identify defect locations or apply handwritten input.

The data acquisition device can be arranged in a stationary manner as is provided for in one embodiment. For the capture of production-related data, however, the data acquisition device can also be associated with a worker as is provided for in another embodiment. The worker constantly personally carries the data acquisition device, in connection with this embodiment, so that there results the acquisition of production-related data by a person.

It is also, however, possible that, at the beginning of a first predetermined finishing or fabricating section of the series production process, a data acquisition device is associated with each produced object and that the data acquisition device stays with the respective produced object until a second predetermined finishing section is reached. In this embodiment, the data acquisition device accompanies the produced object during the finishing process so that the acquisition of production-related data, especially the capture of pictures of defect locations on the produced object, occurs in a production-related manner.

In particular in the embodiment in which the data acquisition device is associated with a worker, it is useful if, preferably from the beginning of the capture of pictures of defect locations, a code is inputted or read into the data acquisition device associated with the respective produced object of which pictures of defect locations thereof are to be captured so as to thereby identify the produced object, whereby, together with the captured pictures or separate therefrom, data is transmitted to at least one central device which contains the code for identification of the respective produced object which has had pictures thereof captured by the camera and transmitted to at least one central device. In this embodiment, a clear association of the captured pictures to the respective produced object is ensured. In this connection, the code is transmitted with each captured picture to at least one central device. It is also, however, possible that the code is transmitted before commencing the taking of a plurality of pictures. All thereafter-following captured and transmitted pictures are then clearly associable with a particular produced object. If the thereafter-following pictures of defect locations are taken with respect to another produced object, the code associated with this other respective produced object is transmitted to at least one central device before the beginning of the transmission of pictures thereto.

In connection with the above-noted embodiment, the code for identification of the produced object can be inputted or read into the data acquisition device in any suitable desired manner. An advantageous further configuration of this embodiment provides that the code is transmitted in a wireless manner and, especially, is transmitted via a transponder. In this embodiment, the transmission of the code to the data acquisition device follows automatically without the intervention of a worker. This saves time and, consequently, reduces costs.

The code for identifying the produced object can be any suitable desired code such as, for example, a numerical and/or letter code. An especially advantageous further configuration provides, however, that the code for identifying the produced object is a graphical code and, especially, a line code (bar code), and that the graphical code is captured by means of a camera. If the graphical code is, for example, a bar code, which is exhibited on the produced object, this bar code can be photographed by means of a camera and can be transmitted together with the captured pictures to the central device. The de-coding of the bar code can then occur at the central device so that it is no longer required to provide a scanner for a bar code at each data acquisition device. This considerably reduces the cost for the data acquisition devices.

In the above-noted embodiment, the graphical code can, together with the captured pictures, be transmitted to the at least one central device or can be transmitted separate from the pictures and, following its transmission, can be de-coded to identify the produced object.

It is also, however, possible that the graphical code is de-coded before the transmission thereof to the at least one central device.

An exceptionally advantageous further configuration of the above-noted embodiment provides that the graphical code is stored and de-coded by means of a picture processing program. In this embodiment, the de-coding of the graphical code is performed by means of a computer program on the otherwise available computer so that additional hardware for de-coding of the code is basically no longer required. This considerably reduces the device requirements for performing the inventive method and saves, in considerable measure, on costs.

It is, as a general proposition, sufficient that the data acquisition device comprises the camera for the capture of pictures of defect locations. An advantageous further configuration provides, however, that the data acquisition device comprises an input device for the inputting of data. In this embodiment, additional data with respect to the pictures can, for example, be inputted and transmitted together with the pictures to the at least one central device. For example, via a touch screen or keyboard, text associated with the pictures is inputted which identifies, for example, the location and/or the type of a defect in a more exact manner.

An exceptionally advantageous further configuration of the above-identified embodiment provides that the input device comprises an audio input device for the recording of audio information, whereby the audio information, together with the captured pictures or separate therefrom, is transmitted as additional data to the at least one central device. In this embodiment, the captured pictures can be further explained via the audio information. Such audio information can be transmitted to the central device or can be listened to by workers who undertake the follow-on work in conjunction with their viewing of the captured pictures. In this manner, there is provided a highly user-friendly capability and, as the occasion requires, the necessary follow-on work is facilitated, which leads to a further time saving and, consequently, to a further cost savings.

The digital picture data can be transmitted via wire or in a wireless manner and, in particular, via radio waves, to the at least one central device.

It is useful that the data acquisition device is configured as a hand-held computer. Such computers are cost favorable and easily serviced.

The invention is described hereinafter in closer detail in connection with an embodiment having reference to the enclosed drawings.

It is shown:

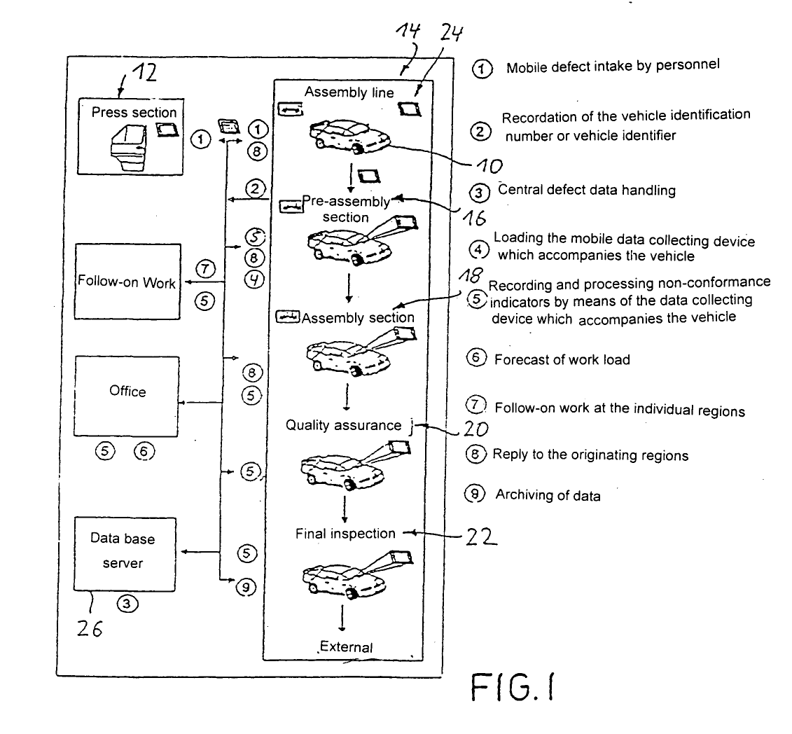

FIG. 1 a schematic view of the path of a finishing process in a series production process of motor vehicles, whereby the inventive process for the capture of production-related data is used in connection therewith,

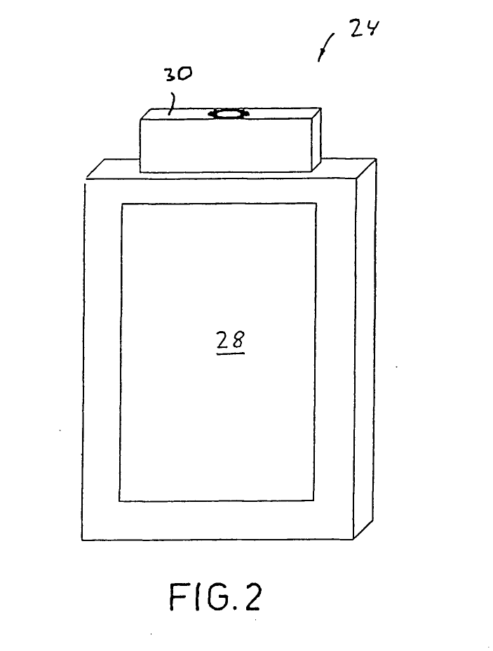

FIG. 2 a decidedly schematic view of a data acquisition device in the form of a hand-held computer with a digital camera connected thereto,

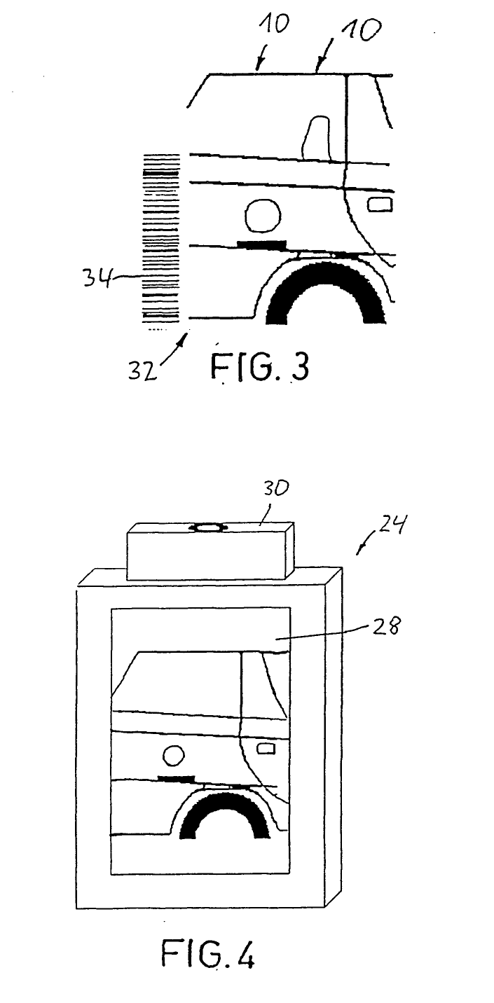

FIG. 3 a photographic representation of a defect location in the form of a surface coating damage location on a vehicle,

FIG. 4 is the same illustration as shown in FIG. 2 of the computer, whereby, by means of the camera, the defect location shown in FIG. 3 on the vehicle is captured and is displayed on the screen of the computer, and

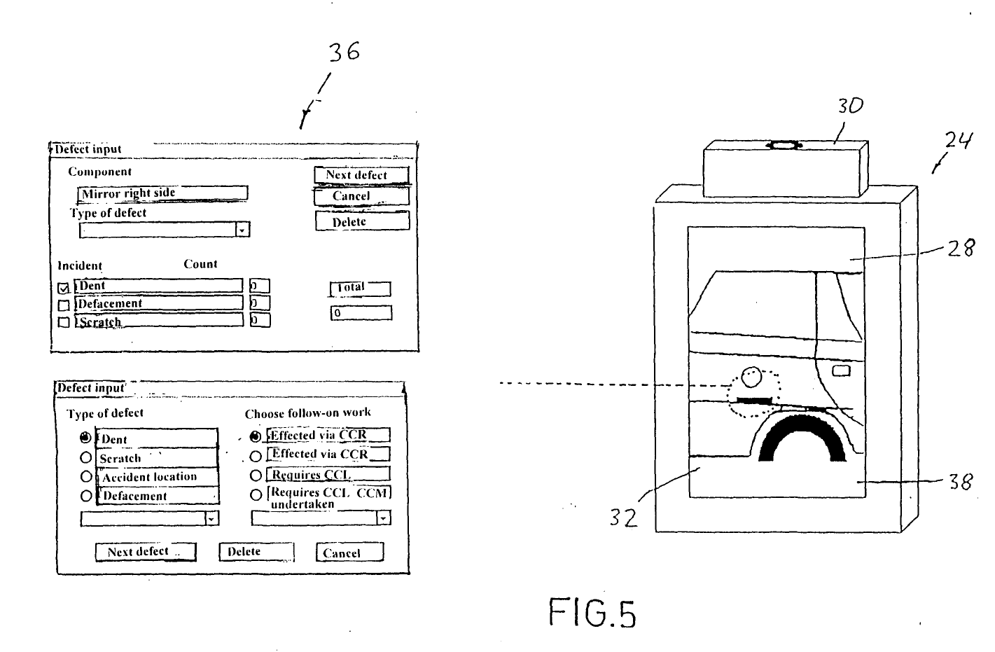

FIG. 5 is the same illustration as shown in FIG. 4 of the computer whereby, in FIG. 5, an input mask is shown on the left which is displayed on the screen display device of the computer and which provides the capability for more exact characterization of defect locations.

In FIG. 1, there is schematically illustrated the path of a series production process of produced objects which are configured as motor vehicles 10. The produced objects pass, in this connection, through various fabricating or finishing sections which, in this embodiment, are configured as a finishing section 12 (press station), 14 (body structure, surface coating application), 16 (pre-assembly), 18 (assembly), 20 (quality assurance) and 22 (end control), whereby each of these finishing sections 12-22 can be partitioned or divided into further finishing sections.

The finishing of the vehicle 10 is completed in the finishing sections 12-22, whereby, in the individual finishing sections 12-22, the respective required components or component sub-assemblies are made available and are assembled by workers. The finishing sections 14-22 can, for example, be configured in the form of different regions in an assembly line which is not further illustrated in the drawing.

Data acquisition devices 24 in the form of hand-held computers are provided for the capture of production-related data in the series production process of vehicles 10, the data acquisition devices 24 each comprising a digital camera for the capture of pictures of defect locations on the vehicles 10 and being described in more detail hereinafter with reference to FIG. 2. The data acquisition devices 24 comprise, respectively, a sending and receiving device which, in the embodiment, is configured as a radio sender and receiver so that the transmission of captured production-related data to a central device 26 is performed in a wired manner.

Defect locations within the context of the invention can, for example, be those locations at which the produced object is damaged such as, for example in connection with a vehicle, a dent, a surface coating damage location, or a defective component or locations not measuring up to predetermined quality standards such as, for example, the exceeding of predetermined gap measurements on the chassis of a vehicle. Defect locations can, however, also be locations at which, for example, a component is missing such as, for example, a windshield wiper of a vehicle.

The data acquisition devices 24 are each respectively associated with a worker at the finishing sections 12 and 14, the worker constantly personally carrying the respective data acquisition device 24 and entering the serially following inputted data of production-related data in the series finishing.

In contrast, at the commencement of passage through a first predetermined finishing section which, in the embodiment, is the finishing section 16, a data acquisition device 24 is associated with each vehicle 10, whereby the data acquisition device 24 of the respective vehicle 10 remains fixedly mounted thereto until a second predetermined finishing section is reached which is, in the embodiment, a finishing section 22.

The logical association of a certain data acquisition device 24 to a certain vehicle 10 is performed via the inputting or reading of the vehicle number of this vehicle into the data acquisition device 24. This inputting can, for example, be performed via a keyboard or a scanner with which a bar code displayed on the vehicle 10 can be scanned which represents the vehicle number. The scanner can be basically separate from the data acquisition device 24 and arranged in a separate device. The vehicle number is transmitted in a suitable manner with the logical association thereof to a data acquisition device 24 to the vehicle 10. The vehicle number can, however, also be transmitted in a wireless manner such as, for example, via a transponder, from the vehicle 10 to the data acquisition device 24. The spatial association of a data acquisition device 24 to a vehicle 10 during the passage of the vehicle through the finishing sections 16-22 is effected in a manner such that a type of docking station in which the data acquisition device 24 is disposed is provided on the vehicle 10 or in physical proximity thereto.

FIG. 2 shows, in a decidedly schematic representation, a data acquisition device 24 which, in this embodiment, is configured as a hand-held computer. The data acquisition device comprises a screen display device 28 in the form of a touch screen-type picture screen 28. Moreover, the data acquisition device 24 comprises an input device, not further illustrated in FIG. 2, for the inputting of data such as, for example, data of the type inputted via a keyboard and/or a mouse or the like.

In accordance with the invention, the capture of production-related data in at least a portion of the finishing sections 12-22 of the series production process is effected by the capture by a camera of pictures of defect locations on the vehicles 10 and the captured pictures are transmitted during the finishing process to the central device 26. In this connection, the data acquisition device 24 comprises a digital camera 30 which is configured as a separate module and is connected to the data acquisition device 24 via a port thereon.

The not further illustrated input device of the data acquisition device 24 further comprises an audio input device with a microphone 31 which serves for characterization of audio information, whereby the audio information, together with the captured pictures or separate therefrom, are transmitted to the central device 26 as additional data relative to the pictures.

The inventive capture of pictures of defect locations is described in further detail with reference to FIGS. 3 and 4.

FIG. 3 shows a vehicle 10 which has a defect location 32 in the region of a fender in the form of a surface coating damage location.

A graphical code in the form of a bar code 34 is shown in FIG. 3 to the lower left thereof which is displayed during the finishing process on the vehicle 10 and represents a vehicle number of the vehicle 10 and, thus, serves for identifying the vehicle 10.

Upon determining the presence of the defect location 32 on the vehicle 10, the worker consequently captures a picture of the defect location 32 by means of the digital camera 30 such that the picture is displayed on the touch screen 28, as can be seen in FIG. 4. The captured picture is stored in a memory of the data acquisition device 24 and is transmitted in the form of digital picture data via the radio transmitter of the data acquisition device 24 to the central device 26, which receives the digital picture data via its radio receiver.

The captured picture can be displayed on a screen display device at the central device 26 so that the type of defect on the vehicle 10 is immediately visible to personnel active at the central device 26 viewing the picture. The central device 26 can, for example, be disposed in a region in which the follow-on work on the vehicles is undertaken. However, a plurality of central devices 26 can also be provided which are disposed at different regions in which different follow-on work is undertaken. The central device 26 can, however, also be configured, for example, as a server, in which the captured pictures and, as the occasion arises, the further production-related data, and from which the captured pictures are achieved are transmitted to those regions in which the follow-on work is undertaken.

In this manner, the planning of such follow-on work as may be necessary in connection with a vehicle 10 can already be effected at a point in time in which this vehicle 10 is still underway in the finishing process. This facilitates the planning of follow-on work considerably and leads to a time saving and, consequently, to a cost saving. Since the defect locations are displayed as pictures, the type of defect involved therewith can be immediately seen.

The photographic representation of digital locations facilitates, moreover, the inputting of data by the worker in the finishing process since, as a general proposition, it is no longer necessary that production-related data such as, for example, data for identifying the defect locations, be manually inputted into the data acquisition device 24.

In this embodiment, the association of a captured picture to the respective vehicle 10 is effected via the bar code 34, which represents the vehicle number of the respective vehicle 10. In the finishing sections 12 and 14, in which the picture capture of defect locations is effected by personnel, the bar code 34 can, for example, be photographed at each picture capture of a defect location by means of a digital camera 30 and can be transmitted together with the respective picture to the central device 26, so that, in connection with the bar code 34, it can clearly be determined at the central device 26 which particular produced object 10 is associated with a defect location.

A de-coding of the bar code 34 can be performed after transmission of the bar code to the central device 26. It is also, however, possible that the de-coding of the bar code 34 is effected before the transmission thereof to the central device 26.

In this embodiment, the de-coding of the bar code is effected such that the photographed bar code, which has been photographed by the digital camera 30, is stored in digital form in a memory of the data acquisition device 24 and is de-coded via a picture processing program in the data acquisition device 24. After the de-coding by means of the picture processing program, the vehicle number of the vehicle 10, together with the captured pictures of defect locations, is transmitted to the central device 26. In this manner, the logical association of captured pictures to the respective vehicle 10 is possible in a simpler, more rapid, and more cost favorable manner without the need for additional hardware such as, for example, hardware in the form of a scanner for the scanning of bar codes.

In the finishing sections 16-22, in which a data acquisition device 24 is fixedly disposed and associated with each vehicle 10, the logical association of captured pictures to the respective vehicle 10 can be effected, for example, via disposition of the data acquisition device 24 in the vehicle 10 such that an initial photograph of the bar code 34 is taken and the bar code is de-coded in the data acquisition device 24. During the passage through each of the finishing sections 16-22, pictures of a defect location which are captured are transmitted with the vehicle number of the respective vehicle 10 which is associated with the respective data acquisition device 24.

The captured pictures can, if necessary, be subjected to follow-on work before transmittal thereof to the at least one central device, especially to achieve more exact identification and/or classification of the defect locations. For example, additional markings or the like can be applied to the pictures by means of a picture processing program disposed in a memory of the data acquisition device 24.

It is also possible to provide the pictures with additional information. In this connection, FIG. 5 shows, on the left-hand side thereof, an input mask 36 which, for example, following touch activation of a selection field 38 on the touch screen 28, is displayed on the touch screen 28. The worker can, via this input mask 36, enter data by hand if required, which, for example, further characterizes the type of a defect location. Thus, for example, in connection with the inputting of a surface coating damage location, information can be entered whether such damage relates to a dent, an indentation, or a scratch. It is also possible to input information that a particular component is missing. The manually inputted additional data can, together with the associated captured pictures, be transmitted to the central device 26.

In the event it is required, the audio input device can be used for audio information and, together with the captured pictures, such audio information can be transmitted to a central device. This audio information can, for example, serve to describe a defect which is shown on a captured picture in further detail, in the event that such is required. Typically, however, the captured pictures are self-explanatory so that such additional data is, as a general proposition, not required.

The inventive process makes possible, in a simpler, more comfortable, and more rapid manner, a documentation of defects of the vehicles 10. Since the captured pictures of defect locations and as the case may arises, data in addition to the pictures, can already be made available to, and evaluated by, the central device 26 at a point in time during which the respective vehicle 10 is still in passage through the finishing process, the planning of such follow-on work as may be required is simplified. This saves time, and, consequently, costs and raises the quality of the produced object, in that, for example during the finishing process, systematic defects which occur are recognized at an early time and can be remedied.

1. A method for making available production-related data in a series production process for the production of produced objects, especially motor vehicles,
in accordance with which, during at least a portion of the finishing sections of the series production process, a worker captures production-related data via a hand-held data acquisition device having an information input component,
characterized in that,
pictures of defect locations on the produced objects are captured by means of a camera associated with the data acquisition device and
the pictures are transmitted during the performance of finishing work on the produced objects in the series production process to at least one central device.

2. A method according to claim 1, characterized in that, a digital camera is used to capture pictures of defect locations.

3. A method according to claim 1, characterized in that, the pictures are transmitted in the form of digital picture data to the central device.

4. A method according to claim 1, characterized in that, the pictures are taken by workers.

5. A method according to claim 1, characterized in that, the data acquisition device comprises a screen display device for the display of captured pictures.

6. A method according to claim 5, characterized in that, the screen display device is configured as a touch screen via which the production-related data gathered by a worker is inputted into the data acquisition device.

7. A method according to claim 1, characterized in that, the captured pictures are, as required, subjected to follow-on work before transmission thereof to at least one central device, especially for more exact identification and/or classification of defect locations.

8. A method according to claim 1, characterized in that, the data acquisition device is associated with a respective worker.

9. A method according to claim 1, characterized in that, at the beginning of a first predetermined finishing section of the series production process, a data acquisition device is associated with each produced object and that the data acquisition device stays with the respective produced object until a second predetermined finishing section is reached.

10. A method according to claim 1, characterized in that, preferably from the beginning of the capture of pictures of defect locations, a code is inputted or read into the data acquisition device associated with the respective produced object of which pictures of defect locations are to be captured so as to thereby identify the produced object, whereby, together with the captured pictures or separate therefrom, data is transmitted to at least one central device which contains the code for identification of the respective produced object which has had pictures thereof captured by the camera and transmitted to at least one central device.

11. A method according to claim 10, characterized in that, the code is transmitted in a wired manner to the data acquisition device, in particular via a transponder.

12. A method according to claim 10, characterized in that, the code for identifying the produced object is a graphical code, in particular, a line code (bar code) and the graphical code is captured via the camera.

13. A method according to claim 12, characterized in that, the graphical code is, together with the captured pictures, transmitted to the at least one central device or is transmitted separate from the pictures and, following its transmission, is de-coded to identify the produced object.

14. A method according to claim 12, characterized in that, the graphical code is de-coded before the transmittal thereof to the at least one central device.

15. A method according to claim 12, characterized in that, the graphical code is stored in memory and is de-coded by means of a picture processing program.

16. A method according to claim 1, characterized in that, the input device comprises an audio input device for the recording of audio information, whereby the audio information, together with the captured pictures or separate therefrom, is transmitted as additional data to the at least one central device.

17. A method according to claim 3, characterized in that, the digital picture data and, as the occasion arises, the further data relating to the picture data are transmitted in a wired manner or in a wireless manner, in particular, in a wireless manner via radio, to the at least one central device.

18. A method for making available production-related data in a series production process for the production of produced objects, especially motor vehicles, the method comprising:
during at least a portion of the passage of the produced objects through a plurality of finishing sections of the series production process, capturing by photographing means production-related data concerning non-conforming locations on the produced objects, the photographing means being associated with a data acquisition device in a manner such that captured production-related data can be inputted to the hand-held data acquisition device; and
transmitting the captured production-related data from the data acquisition device to at least one central device during a time period during which finish work still remains to be performed on the produced object during its passage through the plurality of finishing sections of the series production process.

19. A method according to claim 18, wherein the photographing means is a digital camera operable to capture pictures of non-conforming locations.

20. A method according to claim 18, wherein the production-related data comprises pictures transmitted in the form of digital picture data to the central device.

21. A method according to claim 18, wherein the production-related data comprises pictures taken by workers.

22. A method according to claim 18, wherein the data acquisition device comprises a screen display device for the display of captured pictures.

23. A method according to claim 22, wherein the screen display device is configured as a touch screen via which the production-related data gathered by a worker is inputted into the data acquisition device.

24. A method according to claim 18, wherein the production-related data comprises captured pictures which are, as required, subjected to follow-on work before transmission thereof to at least one central device, especially for more exact identification and/or classification of defect locations.

25. A method according to claim 18, wherein the data acquisition device is associated with a respective worker.

26. A method according to claim 18, wherein at the beginning of a first predetermined finishing section of the series production process, a data acquisition device is associated with each produced object and that the data acquisition device stays with the respective produced object until a second predetermined finishing section is reached.

27. A method according to claim 18, wherein the production-related data comprises pictures and, preferably from the beginning of the capture of pictures of non-conforming locations, a code is entered into the data acquisition device associated with the respective produced object of which pictures of non-conforming locations are to be captured so as to thereby identify the respective produced object, whereby, by means of a selected one of a bundled transmission with the captured pictures or non-bundled transmission separate from the captured pictures, data is transmitted to at least one central device which contains the code for identification of the respective produced object which has had pictures thereof captured by the camera for subsequent transmittal to at least one central device.

28. A method according to claim 27, wherein the code is transmitted in a wired manner to the data acquisition device, in particular via a transponder.

29. A method according to claim 27, wherein the code 34 for identifying the produced object is a graphical code, in particular a line code (bar code), and the graphical code is captured via the photographing means.

30. A method according to claim 29, wherein the production-related data comprises pictures and the graphical code is transmitted to the at least one central device by means of a selected one of a bundled transmission with the captured pictures or non-bundled transmission separate from the captured pictures, and, following its transmission, the graphical code is de-coded to identify the produced object.

31. A method according to claim 29, wherein the graphical code is de-coded before the transmittal thereof to the at least one central device.

32. A method according to claim 29, wherein the graphical code is stored in memory and is de-coded by means of a picture processing program.

33. A method according to claim 18, wherein the production-related data comprises pictures and the data acquisition device comprises an audio input device for the recording of audio information, whereby the audio information, by means of a selected one of a bundled transmission with the captured pictures or non-bundled transmission separate from the captured pictures, is transmitted as additional data to the at least one central device.

34. A method according to claim 20, wherein the production-related data comprises pictures and digital picture data and, as the occasion arises, the further data relating to the pictures, are transmitted in a selected one of a wired manner and a wireless manner, in particular, in a wireless manner via radio, to the at least one central device.
